(19) United States
(12) Patent Application Publication
(10) Pub. No.: US 2007/0201239 A1
(43) Pub. Date: Aug. 30, 2007

(54) Display Device For A Vehicle

(76) Inventors: Daniel Rosario, Santa Cruz, CA (US); Cedric Dupont, Sunnyvale, CA (US); Arne Stoschek, Palo Alto, CA (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/625,480

(22) Filed: Jan. 22, 2007

Related U.S. Application Data
(63) Continuation of application No. PCT/EP05/07574, filed on Jul. 13, 2005.

(51) Int. Cl. G01D 11/28; B60Q 1/00

(52) U.S. Cl. 362/489; 362/23

(57) ABSTRACT

A display device for a motor vehicle is used to display a number relating to the motor vehicle or a symbol relating to the motor vehicle. The display device has a layer made of a light-emitting polymer for emitting light of a first colour, a transparent carrier layer and a mask which is arranged on the transparent carrier layer and provided with an opening in the form of the number or signal, or the display device has a layer made of a first light-emitting polymer for emitting light of a first colour and a second layer, which is arranged close to the first layer and which is made of a second light-emitting polymer for emitting light of a second colour.

### CROSS-REFERENCE TO RELATED APPLICATION

This application is a continuation of co-pending International Application No. PCT/EP2005/007574, filed Jul. 13, 2005, which designates the United States, and claims the benefit of U.S. Provisional Patent Application No. 60/590,136 filed Jul. 22, 2004.

### TECHNICAL FIELD

The invention concerns a display device for a vehicle to display a number concerning the vehicle or a symbol concerning the vehicle.

### BACKGROUND

A display instrument with quasi-continuous presentation, similar to a dial instrument, especially for instrument panels of vehicles, for example, tachometer, oil pressure or temperature display, with a cover plate and several individually controllable light diodes arranged next to each other in this cover plate, is known from DE 35 00 899 A1, in which a printed circuit board is provided, in which the light diodes are held by means of solder connections, the cover plate having matching recesses for the individual light diodes, in which the adjacent matching recesses of adjacent light diodes are separated by preferably very narrow connectors, the cover plate being made from a non-transparent material, especially metal, and the cover plate being rigidly connected to the circuit board.

An electroluminescence number sheet with a support part designed as a plate or foil, with an electroluminescence component that is mounted on the support part, as well as with a number sheet, is known from DE 43 19 441 A1, in which the number sheet is pressed onto the support part provided with the electroluminescence component. A metal layer is pressed onto the support part and the electroluminescence component is pressed on this in the fashion of a phosphor layer. A conducting layer is also pressed between the pressed number sheet and phosphor layer, the metal layer and the conducting layer having electrode connections.

A display element, especially for a vehicle, is known from WO 03/016086, which has a first analog display with a number sheet and a dial and a second digital display, which is visible during a corresponding control for the viewer from the same viewing point as the number sheet, the second display being arranged through a transparent display in front of the plane of the number sheet and parallel to it on the side facing the viewer, and designed for the information display as a self-emitting display. The second display has an organic light-emitting substance or a polymer. The second display is arranged in front of the dial seen by the viewer and simultaneously forms the cover glass. The second display consists of plastic material. The graphics of the number sheet are translucent, in which, behind the number sheet, a flat transillumination, configured as an organic light-emitting component, is arranged.

### SUMMARY

In a display device for a vehicle to display a number concerning the vehicle (for example, as part of an analog display or a digital display) or of a symbol concerning the vehicle, the display device may include a layer of a light-emitting polymer to emit light of a first color (for example, white, blue, green, yellow or red), a transparent support layer and a mask arranged on the transparent support layer, especially on a side of the transparent support layer facing away from the layer of light-emitting polymer, with an opening in the form of the number of symbol.

### BRIEF DESCRIPTION OF THE DRAWINGS

FIG. 1 shows a practical example of a display device for a vehicle for display of a number concerning the vehicle or a symbol concerning the vehicle; FIG. 2 shows a cutout of a cross-section of the display device according to FIG. 1 and FIG. 3 shows the display device according to FIG. 1 in a rear view.

### DETAILED DESCRIPTION

According to an embodiment, a transparent electrode, for example, from indium tin oxide (ITO), can be arranged between the transparent support layer and the layer of light-emitting polymer.

According to another embodiment, the transparent support layer may consist essentially of a flexible material, essentially a flexible plastic. In this manner, cost-effective display devices with a non-flat display surface can be produced particularly suitably.

According to another embodiment, a light-emitting polymer may comprise a spiro compound, for example, a spiro compound according to the formula 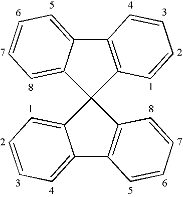
Details of such spiro compounds can be deduced from EP 0 676 461 B1 (incorporated by reference) or U.S. Pat. No. 5,840,217 (incorporated by reference). In an alternative embodiment, the light-emitting polymer comprises polyphenylenevinylenes (PPV), for example,
R-PPV, i.e., 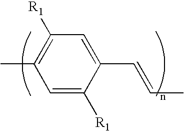
or CN-PPV, i.e., 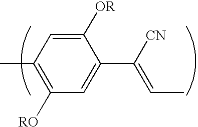
or polyfluorenes. Methods for dissolution of polymers for subsequent printing (for example, on the transparent support or on an electrode arranged on the transport support) can be deduced, for example, from WO 03/019694 A2 (incorporated by reference) or DE 101 41 624 A1 (incorporated by reference).

According to another embodiment, the display device includes at least one layer of a light-emitting polymer for emission of light of at least a second color (different from the first color). In another embodiment, the display device also includes a layer of light-emitting polymer for emission of light of a third color (different from the first color and the second color).

According to another embodiment, the layer of light-emitting polymer is a layer applied by means of an inkjet method.

According to an embodiment, in a display device for a vehicle for display of a number concerning the vehicle (for example, as part of an analog display or a digital display) or of a symbol concerning the vehicle, the display device may include a transparent support layer and a layer of light-emitting polymer for emission of light of a first color (for example, white, blue, green, yellow or red) applied by means of an inkjet method onto the transparent layer.

According to another embodiment, the transparent support layer essentially consists of flexible material, especially essentially flexible plastic.

According to another embodiment, the light-emitting polymer includes a spiro compound. In an alternative embodiment, the light-emitting polymer includes polyphenylenevinylenes (PPV), for example, R-PPV or CN-PPV, or polyfluorenes.

According to another embodiment, the display device may include a layer of a light-emitting polymer for emission of light of a second color (different from the first color). According to another embodiment, the display device also may include a layer of a light-emitting polymer for emission of light of a third color (different from the first color and the second color).

According to an embodiment, in a display device for a vehicle for display of a number concerning the vehicle (for example, as part of an analog display) or of a symbol concerning the vehicle, the display device may comprise a layer of a first light-emitting polymer for emission of light of a first color (for example, white, blue, green, yellow or red) and a second layer arranged next to the first layer from a second light-emitting polymer for emission of light of a second color (different from the first color).

According to one embodiment, the first layer from the first light-emitting polymer and the second layer from the second light-emitting polymer can be each layers applied by an inkjet method.

According to another embodiment, the first layer from the first light-emitting polymer and the second layer from the second light-emitting polymer can be arranged on a common transparent support layer. According to another embodiment, a transparent electrode can be arranged between the transparent support layer and the first layer of the light-emitting polymer and between the transparent support layer and the second layer of the second light-emitting polymer.

According to another embodiment, a mask with an opening in the form of the number or symbol can be arranged on a side of the transparent support layer facing away from the first layer from the first light-emitting polymer and the second layer from the second light-emitting polymer.

According to another embodiment, the transparent support layer may consist essentially of flexible material, especially essentially flexible plastic.

According to another embodiment, the first or second light-emitting polymer may include a spiro compound, for example, a spiro compound according to the formula

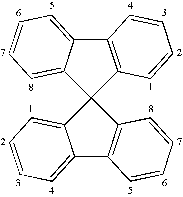

According to an alternative embodiment, the first or second light-emitting polymer may include polyphenylenevinylenes (PPV), for example, R-PPV or CN-PPV, or polyfluorenes.

According to another embodiment, the first and second light-emitting polymer may include a spiro compound, for example, a spiro compound according to the formula

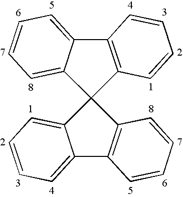

According to an alternative embodiment, the first and second light-emitting polymer may include polyphenylenevinylenes (PPV), for example, R-PPV or CN-PPV, or polyfluorenes.

According to an embodiment, in a display device for a vehicle for display of a number concerning the vehicle (for example, as part of an analog display or a digital display) or of a symbol concerning the vehicle, the display device may include a first layer from a first light-emitting polymer for emission of light of a first color (for example, white, blue, green, yellow or red), a second layer arranged next to the first layer from a second light-emitting polymer for emission of light of a second color (different from the first color) (for example, white, blue, green, yellow or red), and an at least third layer arranged next to the first layer and the second layer from an at least third light-emitting polymer for emission of light of an at least third color (different from the first color and the second color) (for example, white, blue, green, yellow or red).

According to an embodiment, the first layer from the first light-emitting polymer and the second layer from the second light-emitting polymer and the third layer from the third light-emitting polymer are each layers applied by means of an inkjet method.

According to another embodiment, the first layer from the first light-emitting polymer and the second layer from the second light-emitting polymer, the second layer from the second light-emitting polymer and the third layer from the third light-emitting polymer can be arranged on a common transparent support layer. In another embodiment, a transparent electrode is arranged between the transparent support layer and the first layer from the first light-emitting polymer, between the transparent support layer and the second layer from the second light-emitting polymer and between the transparent support layer and the third layer from the third light-emitting polymer.

According to another embodiment, a mask with an opening in the form of the number or symbol can be arranged on a side of the transparent support layer facing away from the first layer from the first light-emitting polymer, the second layer from the second light-emitting polymer and the third layer from the third light-emitting polymer.

According to another embodiment, the transparent support layer may essentially consist of a flexible material, especially essentially flexible plastic.

According to another embodiment, the first, the second and/or the third light-emitting polymer may include a spiro compound, for example, a spiro compound according to formula

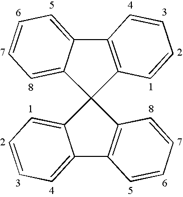

According to an alternative embodiment, the first, the second and/or the third light-emitting polymer may include polyphenylenevinylenes (PPV), for example, R-PPV or CN-PPV, or polyfluorenes.

The vehicle according to an embodiment can be especially a land vehicle, usable in traffic individually. Vehicles according to the embodiments are not restricted, in particular, to land vehicles with internal combustion engines. A symbol according to the application includes all representations, i.e., also numbers, letters, letter combinations, pictures, pictograms, etc.

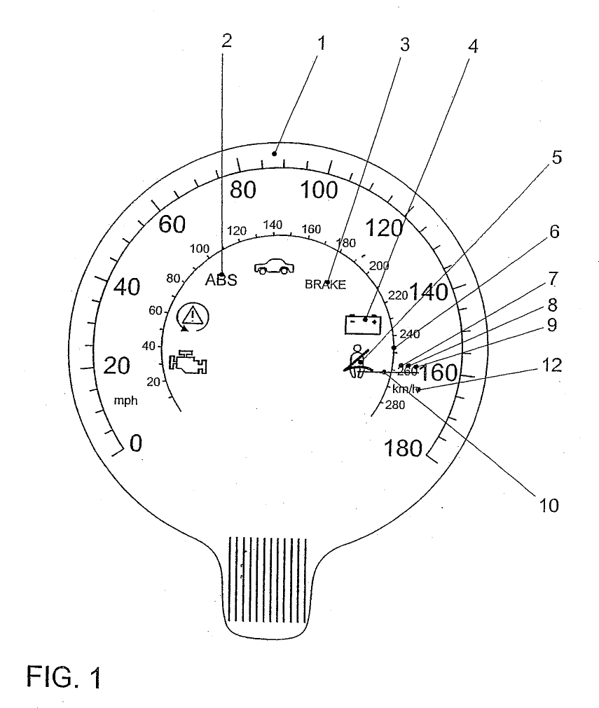

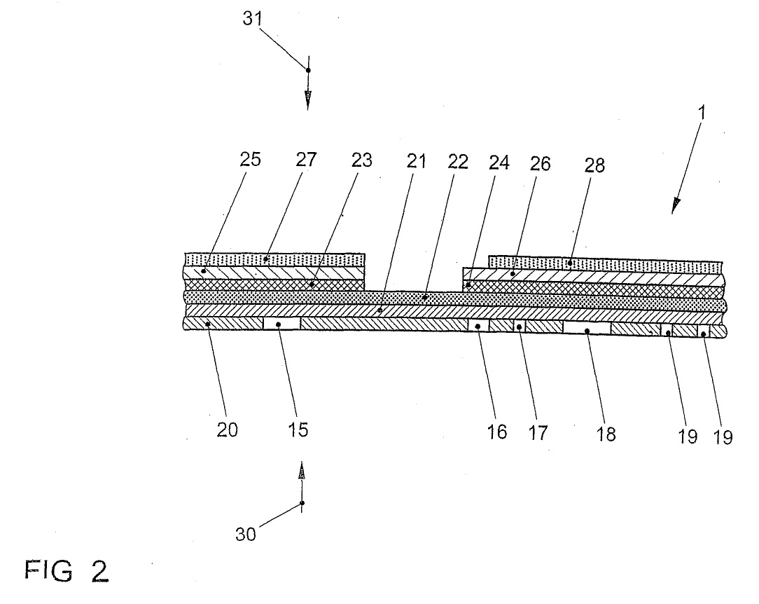

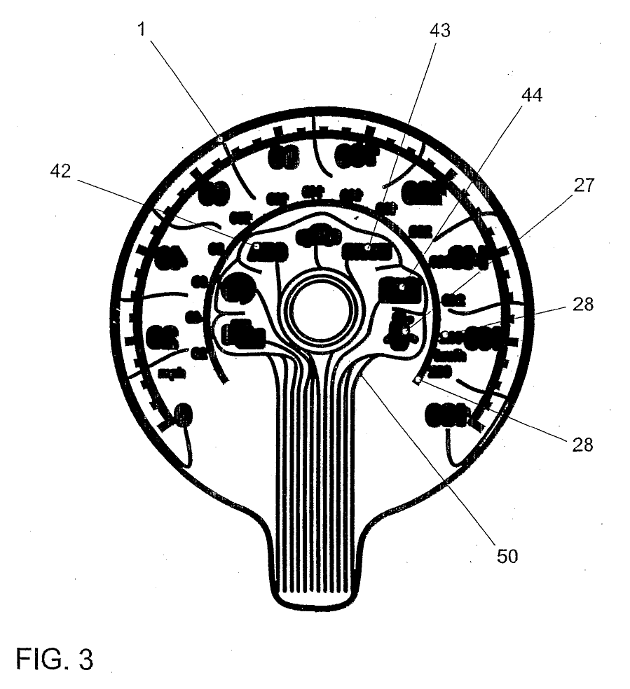

FIG. 1 shows a display device 1 for a vehicle for display of a number concerning the vehicle or a symbol concerning the vehicle. A number concerning the vehicle according to different embodiments can be a number of an analog display, designated with reference numbers 7, 8, 9, as depicted in FIG. 1. A symbol concerning the vehicle according to different embodiments can be, as shown in FIG. 1, a line 6 for an analog display, a unit indication 12 (for example, km/h), a warning signal 2 for a disturbance of an ABS (anti-lock braking system), a warning signal 3 for an applied handbrake, a warning signal 4 for a defect of a generator or a warning signal 5 for an unfastened seatbelt. In one possible practical example, for example, the numbers 7, 8, 9, the unit indication 12 and the line 6 can be blue. The warning signal 3 for the applied handbrake, the warning signal 4 for a defect in the generator and the warning signal 5 for an unfastened seatbelt can be red, for example. The warning signal 2 for a disorder of the ABS can be yellow. It can also be stipulated that the warning signal 2 for a disturbance of the ABS, the warning signal 3 for the applied handbrake, the warning signal 4 for a defect in the generator, the warning signal 5 for an unfastened seatbelt, the numbers 7, 8, 9, the unit indication 12 and the line 6 are white.

FIG. 2 shows a cutout of a cross-section of the display device 1 according to FIG. 1, marked by a bar in FIG. 1 with reference number 10, in which an arrow, designated with reference number 30 in FIG. 2, indicates the viewing direction in FIG. 1. The display device 1 includes a mask 20 with openings 15, 16, 17, 18, 19 in the form of a number to be displayed or the symbol to be displayed. Reference number 15 thus denotes an opening for the warning signal 5. Reference number 16 denotes an opening for line 6, reference number 17 denotes an opening for the number 2, designated with reference 7, reference number 18 denotes an opening for the number 6, designated with reference number 8, and reference number 19 designates an opening for the number 0, designated with reference number 9.

With reference to the viewing direction beneath mask 20, a transparent support layer 21, consisting essentially of flexible material, especially essentially flexible plastic, is arranged. With reference to the viewing direction beneath transparent support layer 21, a transparent electrode 22, for example, made of ITO, is arranged. With reference to the viewing direction beneath the transparent electrode 22, a conducting polymer layer 23 or 24, for example, PANI, PDOT or PSS, is arranged. With reference to the viewing direction beneath the conducting polymer layers 23 and 24 and above the back electrodes 27 and 28, layers 25 and 26 of a light-emitting polymer are arranged.

Spiro compounds, for example, spiro compound according to the formula 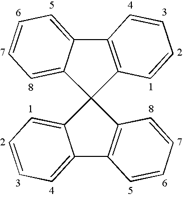
can be used as such light-emitting polymers. Details concerning such spiro compounds can be deduced from EP 0 676 461 B1 (incorporated by reference) or U.S. Pat. No. 5,840,217 (incorporated by reference). Additional details concerning spiro compounds can be deduced from the Internet page
www.covion.com/technology/tech_summary.html (incorporated by reference). For example, it can be stipulated that the light-emitting polymer of layer 25 is Covion PolySpiroRed CR01 and the light-emitting polymer of layer 26 is Covion PolySpiroBlue CB02.

In an alternative embodiment, the light-emitting polymer of layer 25 or layer 26 comprises polyphenylenevinylenes (PPV), for example,
R-PPV, i.e., 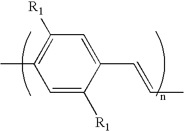
or CN-PPV, i.e., 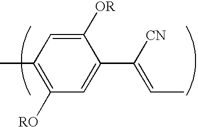
or polyfluorenes. Methods for dissolution of polymers for subsequent printing can be deduced, for example, from WO 03/019694 A2 (incorporated by reference) or DE 101 41 624 A1 (incorporated by reference), as well as the aforementioned Internet site www.covion.com/technology/tech_summary.html.

It can also be stipulated that the light-emitting polymer layer 25 is CN-PPV and the light-emitting polymer layer 26 is Covion PolySpiroBlue CB02.

The design depicted in FIG. 2 is only an example. A different arrangement of the layers can also be stipulated, as disclosed, for example, in U.S. Pat. No. 6,605,483 (incorporated by reference).

FIG. 3 shows the display device 1 according to FIG. 1 in a rear view, in which an arrow, designated with reference number 31 in FIG. 2, shows the viewing direction in FIG. 3. Reference numbers 42, 43 and 44 then designate back electrodes for the depictions of warning signals 2, 3 and 4. An electrical conductor is designated with reference number 50.

The invention permits production of particularly cost-effective and, at the same time, particularly readable display devices for vehicles. The good and rapid legibility is a particularly important property for display devices for vehicles. This support property is achieved cost-effectively by means of the invention.

The display device is also particularly suited for display of a PDC (park distance control). Different color light strips can then indicate the distance to an obstacle.

The layers in the figures are not necessarily marked true to scale, in the interest of simplicity and clarity. For example, the orders of magnitude of some layers are exaggerated relative to other layers, in order to improve understanding of the practical examples of the present invention.

### LIST OF REFERENCE NUMBERS

1 Display device
2, 3, 4, 5 Warning signal
6 Line
7, 8, 9 Number
10 Bar
12 Unit indication
20 Mask
15, 16, 17, 18, 19 Opening
21 Support layer
22 Transparent electrode
23, 24 Conducting polymer layers
25, 26 Layers of a light-emitting polymer
27, 28, 42, 43, 44 Back electrodes
30, 31 Arrow
50 Electrical conductor

What is claimed is:

1. A display device for a vehicle for display of a number concerning the vehicle or a symbol concerning the vehicle, the display device comprising:
a layer of a light-emitting polymer for emission of light of the first color;
a transparent support layer; and
a mask with an opening in the form of the number or symbol arranged on the transparent support layer.

2. The display device according to claim 1, wherein the layer of light-emitting polymer is arranged on the side of the transparent layer facing away from the mask.

3. The display device according to claim 1, wherein the transparent support layer consists essentially of flexible material.

4. The display device according to claim 1, comprising:
a spiro compound.

5. The display device according to claim 1, further comprising:
at least one layer of a light-emitting polymer for emission of light of a second color.

6. The display device according to claim 1, wherein the number is part of an analog display.

7. An analog display for a vehicle for display of a number concerning the vehicle or a symbol concerning the vehicle, the display device comprising:
a transparent support layer; and
a layer of light-emitting polymer for emission of light of a first color applied to the transparent layer.

8. The display device according to claim 7, further comprising:
at least one layer of a light-emitting polymer for emission of light of at least a second color.

9. The display device according to claim 7, wherein the number is part of the analog display.

10. An analog display for a vehicle for display of a number concerning the vehicle or a symbol concerning the vehicle, the display device comprising:
a first layer from a light-emitting polymer for emission of light of a first color; and
a second layer from a second light-emitting polymer arranged next to the first layer for emission of light of the second color.

11. The display device according to claim 10, wherein the first layer from the first light-emitting polymer and the second layer from the second light-emitting polymer are arranged on a common transparent support layer.

12. The display device according to claim 10, wherein a transparent electrode is arranged between the transparent support layer and the first layer of the first light-emitting polymer and between the transparent support layer and the second layer of the second light-emitting polymer.

13. The display device according to claim 10, wherein a mask with an opening in the form of the number or symbol is arranged on the side of the transparent support layer facing away from the first layer of the first light-emitting polymer and the second layer from the second light-emitting polymer.

14. The display device according to claim 10, wherein the transparent support layer consists essentially of flexible material.

15. The display device according to claim 10, wherein the first or second light-emitting polymer comprises:
a spiro compound.

16. A display device for a vehicle for display of a number concerning or a symbol concerning the vehicle, the display device comprising:
a first layer from a first light-emitting polymer for emission of light of the first color;
a second layer arranged next to the first layer from a second light-emitting polymer for emission of light of a second color;
and a third layer from a third light-emitting polymer for emission of light of a third color arranged next to the first layer and the second layer.
